(19) United States
(12) Patent Application Publication
(10) Pub. No.: US 2011/0255787 A1
(43) Pub. Date: Oct. 20, 2011

(54) PORTABLE ELECTRONIC DEVICE

(75) Inventor: JEN-TSORNG CHANG, Tu-Cheng (TW)

(73) Assignee: HON HAI PRECISION INDUSTRY CO., LTD., Tu-Cheng (TW)

(21) Appl. No.: 12/862,768

(22) Filed: Aug. 25, 2010

(30) Foreign Application Priority Data
Apr. 14, 2010 (CN) 201010146721.5

(51) Int. Cl. G06K 9/46

(52) U.S. Cl. 382/190

(57) ABSTRACT

A portable electronic device includes a main body, an image capturing module, a facial recognition module, a fortune telling database, a fortune calculating module, and a display screen. The image capturing module is mounted on the main body and is configured for capturing a portrait image of a user. The facial recognition module is configured for extracting facial features from the portrait image. The fortune telling database is for storing fortune telling data. The fortune calculating module is configured for analyzing the extracted facial features using a predetermined algorithm and searching the fortune telling database according to the analyzed result, thereby retrieving a fortune data the associated with the extracted facial features from fortune telling database. The display screen is for displaying the fortune data.

### BACKGROUND

1. Technical Field

The present disclosure relates to a portable electronic device with fortune telling function.

2. Description of Related Art

Portable electronic devices, such as cell phones, have been more and more popular. Many functions have been incorporated into the portable electronic devices, for example, games, music player. However, people are still desired to have more fun in playing the portable electronic devices.

Therefore, it is desirable to provide a new portable electronic device, which can overcome the above-mentioned limitations.

### BRIEF DESCRIPTION OF THE DRAWINGS

FIG. 1 is a portable electronic device according to an exemplary embodiment.

FIG. 2 is a schematic block diagram of the portable electronic device of FIG. 1.

### DETAILED DESCRIPTION

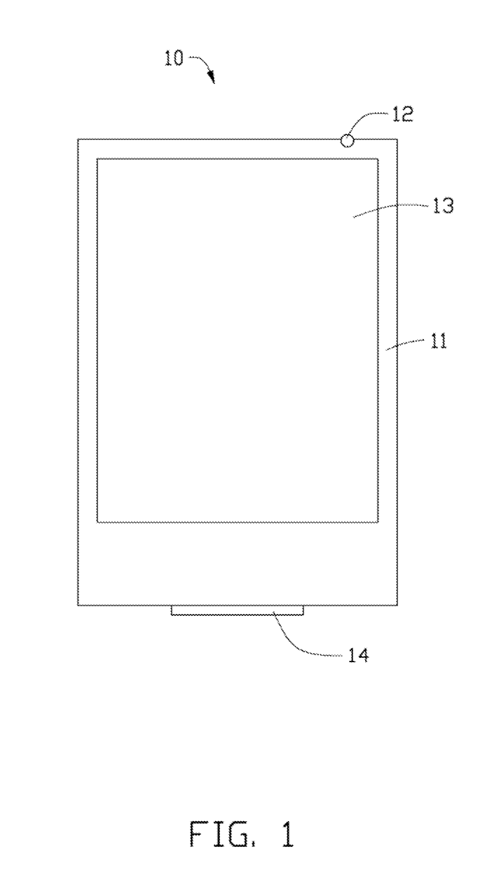

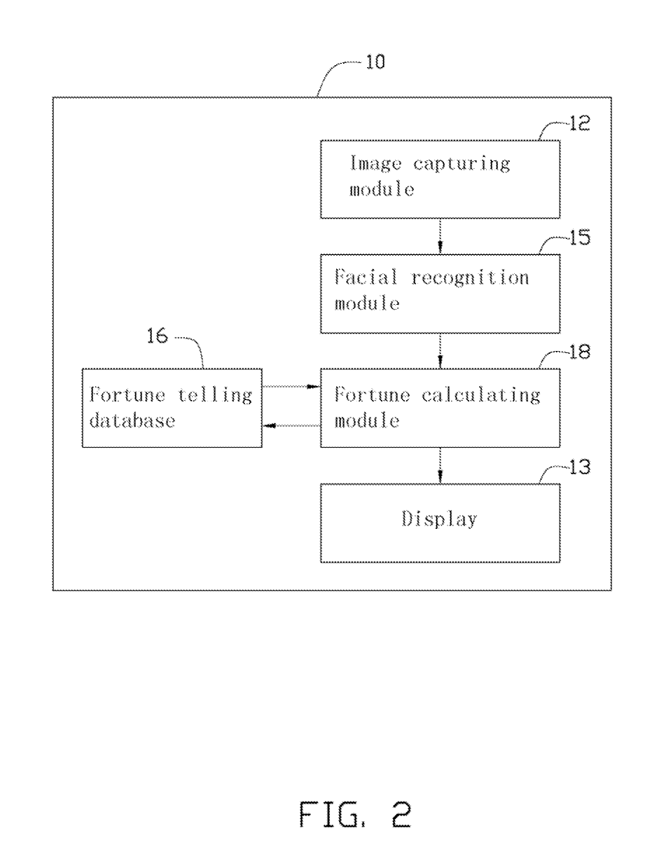

Referring to FIGS. 1-2, a portable electronic device 10 includes a main body 11, an image capturing module 12, a display 13, a connection port 14, a facial recognition module 15, a fortune calculating module 18, and a fortune telling database 16.

The image capturing module 12 is configured (i.e., structured and arranged) for capturing a portrait image of the user of the portable electronic device 10. The portrait image of the user may be shown on the display 13. The image capturing module 12 is rotatably mounted on the main body 11. The image capturing module 12 is capable of rotating in a range of about 180 degrees. The portrait image of the user may be stored in an outside storage device, for example, a personal computer via the connection port 14. The connection port 14 may be a universal serial bus (USB) port.

The facial recognition module 15 is electrically connected with the image capturing module 12. The facial recognition module 15 is configured for extracting facial features from the portrait image. The facial features are selected from the group consisting of face color uniformity, hair styles, eye shapes, nose shapes, mouth shapes, ear shapes, teeth colors, eye colors, face wrinkles, relative position of the eyes and the nose, relative position of the nose and the mouth, and relative position of the mouth and the ears.

The fortune telling database 16 is for storing fortune telling data.

The fortune calculating module 18 is configured for analyzing the extracted facial features using a predetermined algorithm and searching the fortune telling database 16 according to the analyzed result, thereby retrieving a fortune data associated with the extracted facial features from fortune telling database 16. In the present embodiment, the analyzed result is a fortune score. The fortune score is equal to a sum of the product (i.e., the quantity obtained by multiplication) of a score of each facial feature and a weight of the particular facial feature. That is, the fortune score is calculated according to the following equation: the fortune

$$score = {\sum }_{n = 1}^{n = 12} Wn * Sn ,$$

wherein Sn represents the score of a facial feature n (the facial feature n is one of the above twelve facial features: face color uniformity, hair styles, eye shapes, nose shapes, mouth shapes, ear shapes, teeth colors, eye colors, face wrinkles, relative position of the eyes and the nose, relative position of the nose and the mouth, and relative position of the mouth and the ears), Wn represents the weight of the facial feature n.

The display 13 is for displaying the fortune data. The display 13 may be a touch panel.

The portable electronic device 10 may further include a flash (not shown) arranged substantially adjacent to the image capturing module 12 so that the image capturing module 12 can take a clear and bright image during a dark scene. The flash may be a light emitting diode (LED).

The user of the portable electronic device 10 can input any personal information of a person in the portrait image, such as, blood pressure, weight, measurement of a waistline, height, to the portrait image. The portable electronic device 10 can send the portrait image together with the personal information to a health evaluating institution via the connection port 14. Based on the portrait image together with the personal information, the health evaluating institution can obtain health condition of the person, and give some suggestions on health to the person.

While various embodiments have been described, it is to be understood that the disclosure is not limited thereto. To the contrary, various modifications and similar arrangements (as would be apparent to those skilled in the art), are also intended to be covered. Therefore, the scope of the appended claims should be accorded the broadest interpretation so as to encompass all such modifications and similar arrangements.

What is claimed is:

1. A portable electronic device comprising:
a main body;
an image capturing module mounted on the main body and configured for capturing a portrait image of a user;
a facial recognition module configured for extracting facial features from the portrait image;
a fortune telling database for storing fortune telling data;
a fortune calculating module configured for analyzing the extracted facial features using a predetermined algorithm and searching the fortune telling database according to the analyzed result, thereby retrieving a fortune data the associated with the extracted facial features from fortune telling database; and
a display screen for displaying the fortune data.

2. The portable electronic device of claim 1, wherein the facial features are selected from the group consisting of face color uniformity, hair styles, eye shapes, nose shapes, mouth shapes, ear shapes, teeth colors, eye colors, face wrinkles, and relative positions of the eyes, nose, mouth and ears.

3. The portable electronic device of claim 1, wherein the main body comprises a port for connection to a peripheral storage unit.

4. The portable electronic device of claim 3, wherein the port is a universal serial bus port.

5. The portable electronic device of claim 1, being a mobile phone.
